(19) United States
(12) Patent Application Publication
(10) Pub. No.: US 2010/0125355 A1
(43) Pub. Date: May 20, 2010

(54) MODULAR CUSTOM WEAPON STOCK MANUFACTURING

(76) Inventor: Karl C. Lippard, Colorado Springs, CO (US)

Correspondence Address: HOGAN & HARTSON LLP, ONE TABOR CENTER, SUITE 1500, 1200 SEVENTEENTH ST, DENVER, CO, 80202, US

(21) Appl. No.: 12/272,713

(22) Filed: Nov. 17, 2008

(51) Int. Cl. G06F 19/00; G06F 17/50

(52) U.S. Cl. 700/98; 700/117; 700/182

(57) ABSTRACT

A custom gun is fabricated by combining stock design modules. Using a common datum various stock modules can be combined to produce a unique stock configuration. Each of the modular stock components is chosen from the library stock design modules according to the characteristics and the intended use of the gun. This subset of design modules is processed in combination with the physical characteristics of a user to arrive at a customized three-dimensional model of a stock for a gun. The model can thereafter be modified and segmented before all or a portion of the model is output to a computer aided machining device which, using a unitary piece of stock material, can fabricate the stock according to the computer generated model.

### BACKGROUND OF THE INVENTION

1. Field of the Invention

Embodiments of the present invention relate, in general, to gun stocks and particularly to a modular process to produce customized gun stocks.

2. Relevant Background

A weapon's stock enables the weapon to be properly positioned for firing. In the world of competitive shooting it is well known that the stock of each weapon must be tailored or customized for each shooter and for each event so as to achieve the highest degree of performance. Each shooter possesses different physical characteristics. The length of a person's arm, the position of their eyes and the contours of a person's cheekbones all interact with the aim of the weapon. Similarly a weapon configured for hunting is poorly suited for shooting trap and once configured for shooting trap would be misapplied to shooting skeet. In a typical man/weapon interaction scenario, the aim of a weapon refers to the alignment among the eye, the shoulder and the line of the barrel that is indicative of the trajectory of the fired projectile. Clearly, when producing a rifle or shotgun stock, account has to be taken for a variety of parameters including distance and height of the eyes, the length of the neck, the length of the arms, positioning of the weapon on the shoulder, height of the person and finally how the weapon is being used.

A customized stock for a particular weapon takes into account these and other factors and when complete, transforms a generic weapon into a finely tuned instrument tied to one individual. When properly fit, the stock can dramatically increase that individual's ability to accurately aim and employ the weapon. Unfortunately most weapons do not possess customized stocks. Stock customization is costly thus a typical purchase of a rifle or shotgun comes with a standard stock. Generally stock design is based on demographic research that identifies the physical characteristics of the typical purchaser of a certain type of weapon. A generic stock is crafted by an artisan and used as a model or mold for mass replication. As a result the stock and weapon is marginally fit for only a small portion of its purchasers and is accurately fit to none of the purchasers.

One attempt to address the deficient fit of most standard stocks is to offer an adjustable stock. An adjustable stock provides some ability to adjust for a particular shooter's physical characteristics. For example the length of the stock can be increased or a cheek plate can be added to modify the height of the stock. However as with any adjustable system, its ability to accommodate a variety of shooters compromises its ability to perfectly fit any one shooter. Furthermore, a stock's ability to be adjustable requires it comprise multiple components. These additional components add to the complexity of the weapon, the weight of the weapon and unfortunately the likelihood that the weapon's system will fail. The ability to efficiently and precisely manufacture a customized stock from a unitary piece of material remains a challenge.

### SUMMARY OF THE INVENTION

Embodiments of the present invention include systems and processes for producing customized weapon stocks. According to one embodiment of the present invention, a library is created comprising a plurality of modular stock components, also referred to herein as stock design modules. Using a common datum various stock modules can be combined to produce a unique stock configuration. Each of the modular stock components is chosen from the library stock design modules according to the characteristics and desires of a user. This subset of design modules is processed in combination with the physical characteristics of a user to arrive at a customized three-dimensional model of a stock for a gun. Once created, the computer model of the stock is output to a computer aided machining device that, using a unitary piece of stock material, can fabricate the stock according to the computer generated model.

Another embodiment of the present invention includes a method for manufacturing a customized stock for a gun. The method begins with the collection of a set of data representing the physical characteristics of a user. This information is combined with a subset of design modules selected from a plurality of design modules stored in a library. A computer processes the data and the design modules to form a computer model of the stock. Once generated the computer model of the stock is output to a computer aided machining device for fabrication of the stock. According to another embodiment of the present invention the computer model is modified to include a cavity for receiving and mating the stock with the gun.

The features and advantages described in this disclosure and in the following detailed description are not all-inclusive. Many additional features and advantages will be apparent to one of ordinary skill in the relevant art in view of the drawings, specification, and claims hereof. Moreover, it should be noted that the language used in the specification has been principally selected for readability and instructional purposes and may not have been selected to delineate or circumscribe the inventive subject matter; reference to the claims is necessary to determine such inventive subject matter.

### BRIEF DESCRIPTION OF THE DRAWINGS

The aforementioned and other features and objects of the present invention and the manner of attaining them will become more apparent, and the invention itself will be best understood, by reference to the following description of one or more embodiments taken in conjunction with the accompanying drawings, wherein:

FIG. 1 shows a system for fabricating a custom stock for a gun using a computer and a computer aided machining device according to one embodiment of the present invention;

FIG. 2 is a depiction of a representative framework for a three-dimensional model of a customized stock for a gun according to one embodiment of the present invention;

FIG. 3 shows a three-dimensional model of a customized stock for a gun based on user physical characteristics and a subset of stock design modules according to one embodiment of the present invention; and

FIG. 4 is a flowchart of one method embodiment for fabricating a customized stock for a gun according to the present invention.

The Figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF EMBODIMENTS

A system and method for fabricating customized gun stocks using Computer Aided Design (“CAD”) and Computer Aided Machining (“CAM”) tools is herein described. By collecting physical characteristics of a user and combining those with a subset of stock design modules, a computer can form a three-dimensional model of a gun stock that is not only crafted to address the unique physical characteristics of the user but also the intended use of the gun. In addition the three-dimensional model of the stock can be modified via user input to arrive at a true customized stock for a gun. Once complete the model can be output to a CAM device for fabrication of the stock from a unitary piece of stock material.

Specific embodiments of the present invention are hereafter described in detail with reference to the accompanying Figures. Like elements in the various Figures are identified by like reference numerals for consistency. Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention.

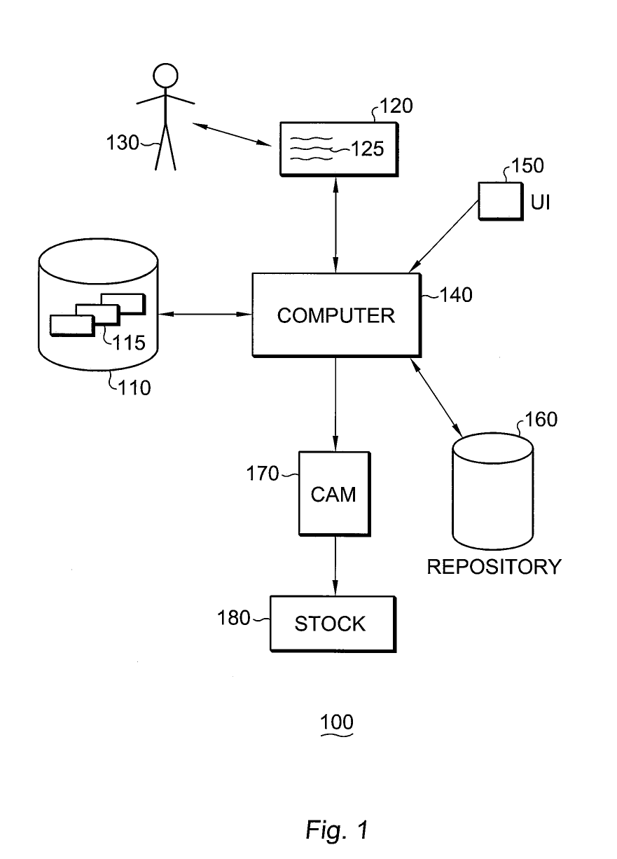

FIG. 1 shows one embodiment of a system for fabricating customized gun stocks according to the present invention. The system 100 includes a computer 140 that is communicatively coupled to a stock design module library 110 and a user characteristic repository 120. The computer 140 is also coupled to a user input interface 150, a tangible storage medium 160 for storing output data and a CAM device 170.

According to one embodiment of the present invention, the computer 140 interacts with the stock design module library 110 and the user characteristic repository 120 to retrieve data needed to form a model of the stock. Information regarding a user's 130 physical characteristics is stored as data sets 125 in the user characteristic repository. As previously discussed certain physical characteristics of a user 130 are key to the fabrication of a correctly fitted stock. A user's gender, arm length, the distance between an individual's shoulder and cheek and so forth drive how the stock should be crafted to correctly position the gun for firing. Similarly how the gun is to be used also affects the design of a stock. A gun used for sport skeet shooting is dramatically different from one used for hunting. Thus beyond the user's physical characteristics the stock must be designed to consider the gun's use.

A plurality of stock design modules 115 is stored in the stock design module library 110. From these modules, based on the user's physical characteristics and the intended use of the gun, a set of modules is selected to form the basis of a three-dimensional model. One skilled in the art will recognize that the stock design module library 110 and the user characteristic repository 120 may comprise any tangible storage medium known to one skilled in the art such as magnetic disks, tape, optical disks, flash drives and the like. And while the two storage mediums are depicted separately in FIG. 1, one skilled in the art will understand that the two repositories may indeed share a common storage medium or similarly distribute the stored data among a plurality of storage mediums such as in a storage area network or the like. Indeed the computer, in another embodiment, can be coupled to a network allowing the data to reside at various locations without impeding on the scope and effectiveness of the present invention.

According to one embodiment of the present invention, a stock can be modeled and fabricated by first collecting and storing physical characteristics of a user, selecting a set of stock design modules and then processing these elements within the computer 140 using CAD technology to form a three-dimensional model of a stock. The model can then be modified via a user interface 150 to accommodate any individual desires or configurations. Once a model of the customized stock has been prepared to the satisfaction of the user, the data can be output to a CAM device 170 which can then fabricate the stock 180 as well as send it to a repository 160 for model storage.

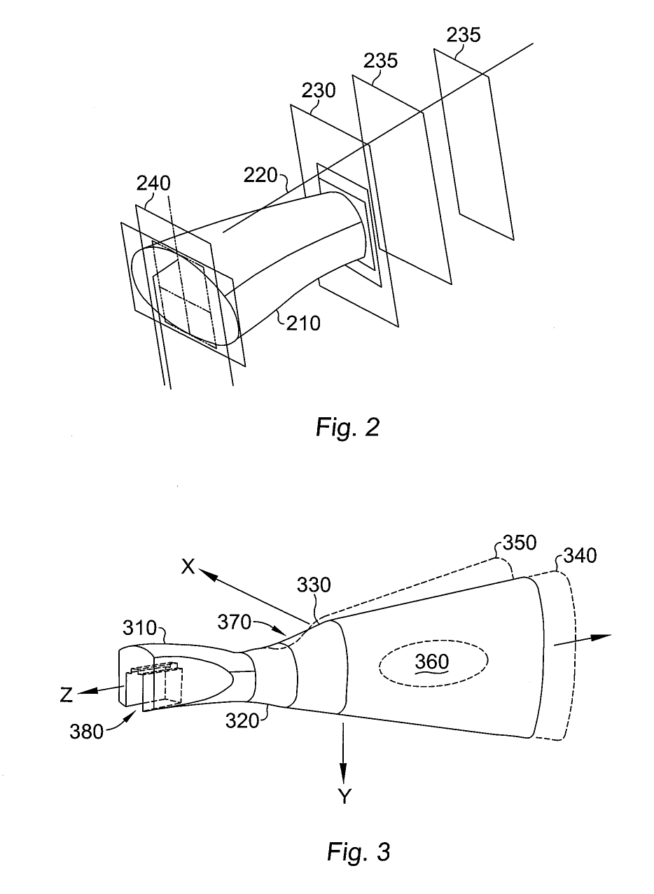

FIG. 2 shows a representative framework for a three-dimensional model of a customized stock for a gun according to one embodiment of the present invention. One of the plurality of stock design modules 210 is selected and placed on a datum 270 that is aligned with the centerline of the gun. In the depiction shown in FIG. 2 the gun would mate with the left hand portion of the left most plane 240 of the depicted module 210 with the trigger housing and base plate occupying a cavity (not shown) designed within the module 210 to accommodate such components.

FIG. 2 further shows a right most juncture 230 at which a second stock design module would be mated with the first design module 210. In the embodiment shown, two additional such junctures 235 are established enabling the stock to comprise three stock design modules. As one skilled in the relevant art will recognize, the number of stock design modules can vary depending on the user's desires, the intended use of the gun and the physical characteristics of the user. In one embodiment a first design module 210 establishes a mating between the gun and the stock. A second design module can be selected to interface with the first module and yet address the need for a gun stock to provide a hand grip. Lastly a third stock design module is added to form the butt portion of the stock fitted to a user's shoulder and cheek.

Each stock design module comprising the library is, according to one embodiment of the present invention, categorized by its placement within a stock configuration. A variety of gun/stock interface sections can exist designed to accommodate known gun configurations. Similarly several necking portions can exist as well as pistol grip configurations and the like.

Each stock design module includes at least one interface surface that can be modified to mate with another design module. For example the right most face 230 of the first stock design module 210 is compatible with a left most face of a second stock design module. Each compatible face is designed to be within pre-established tolerances. Upon the two modules being selected the computer matches the dimensional attributes of the right most face of the first stock design module 210 with the left most face of the second stock design module. A similar process occurs for adding addition stock design modules so as to arrive at a preliminary custom stock model

FIG. 3 shows a three-dimensional model of a customized stock for a gun based on user physical characteristics and a subset of stock design modules according to one embodiment of the present invention. As previously discussed, a preliminary stock can be formed from combining multiple stock design modules. According to one embodiment of the present invention, the selection of the various design stock modules from the design stock module library is automatically determined by comparing the library with the recorded intended use of the weapon and the physical characteristic data of the user. Once the general shape of the stock is formed, the dimensional aspects of each module may be manipulated to arrive at a customized stock.

In the example shown in FIG. 3, a second design stock module 320 is interposed and mated with a first design stock module 310 and a third design stock module 330. Each module is orientated along a Z axis establishing a datum on the Z axis extending in the direction of the Y axis. Once a preliminary model is established, various aspects of the model can be manually manipulated. For example the length of the stock can be increased 340 or the height of the butt stock portion can be adjusted 350. Additionally asymmetric features can be added such as a depression 360 carved from the lateral size of the stock. The modifications can also bridge the interface between modules such as adjusting the length and contour of the handgrip section 370. Finally modifications to the cavity 380 can be made as necessary to accommodate components of the gun as it interfaces with the stock.

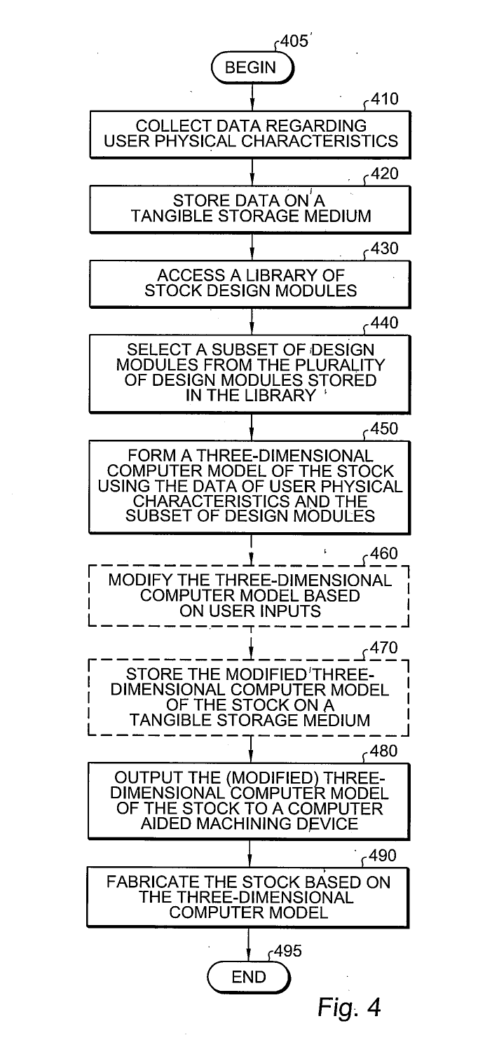

FIG. 4 is a flowchart illustrating methods of implementing an exemplary process for fabricating a custom gun stock using CAD/CAM technology. In the following description, it will be understood that each block of the flowchart illustrations, and combinations of blocks in the flowchart illustrations, can be implemented by computer program instructions. These computer program instructions may be loaded onto a computer or other programmable apparatus to produce a machine such that the instructions that execute on the computer or other programmable apparatus create means for implementing the functions specified in the flowchart block or blocks. These computer program instructions may also be stored in a computer-readable memory that can direct a computer or other programmable apparatus to function in a particular manner such that the instructions stored in the computer-readable memory produce an article of manufacture including instruction means that implement the function specified in the flowchart block or blocks. The computer program instructions may also be loaded onto a computer or other programmable apparatus to cause a series of operational steps to be performed in the computer or on the other programmable apparatus to produce a computer implemented process such that the instructions that execute on the computer or other programmable apparatus provide steps for implementing the functions specified in the flowchart block or blocks.

Accordingly, blocks of the flowchart illustrations support combinations of means for performing the specified functions and combinations of steps for performing the specified functions. It will also be understood that each block of the flowchart illustrations, and combinations of blocks in the flowchart illustrations, can be implemented by special purpose hardware-based computer systems that perform the specified functions or steps, or combinations of special purpose hardware and computer instructions.

As shown in FIG. 4 a method to fabricate a customized gun stock begins 405 with the collection 410 of user physical characteristic data. Once gained the information is input into the system and stored 420 on a tangible storage medium. With the user's physical characteristics on file, the process of modeling and fabricating a stock begins with accessing a stock design module library 430. From the library a subset of stock design modules is selected to form 440 a preliminary stock model. The stock design modules are selected based on the user's physical characteristics and data received indicating the intended use of the gun.

Once the three-dimensional model is formed 450 is examined and, if necessary, modified 460 to accommodate user preferences or aspects of the user that could not be captured by the physical characteristic data. According to one embodiment of the present invention, the three-dimensional model is stored in memory 470 so that should a user need another stock, the model can be easily retrieved even if the physical characteristic data has been lost.

The three-dimensional model of the stock is thereafter output 480 to a CAM device that using a unitary piece of material fabricates 490 a customized stock for the user. The end result 495 of the aforementioned process is a gun stock that is precisely fit to an individual's physical characteristics and desires and designed to facilitate the intended use of the gun.

As one skilled in the relevant art will recognize, the aforementioned procedure may be may be segmented to facilitate the design and manufacturing process. For example a user may elect to design and fabricate the receiving or head portion of the stock without completing during the same manufacturing process the remaining modules defining the stock. Given a particular type of gun, the receiving portion of a blank gun stock can be designed and fabricated leaving the remaining sections in a rough cut status. While the stock can only be used in conjunction with that particular type of gun, the rough cut stock can be subsequently fabricated to meet a number of custom demands at a different time and at a different location. A manufacturer, for example could provide rough cut stocks compliant with a particular type of gun (receiving portion) so as to be finished at a retail customer location. In that manner the customer or user can select a basic type and quality of wood stock and can have the final portions of the stock fit to their physical characteristics.

Similarly, a user can define and fabricate the rear portion of a stock comprised of one or more design stock modules while leaving the receiving portion uncut. Several stock design module can be coupled to a generic receiving stock design module that can be finalized at a later time. With the stock designed and fabricated, the user is free to select the type of gun with which the stock will be used. In another embodiment of the present invention, several renditions of a particular design or configuration can be examined and machined so as to be inspected by the user prior to selection of what gun with which the stock will be mated. In the same manner the same stock design can be applied to multiple types of guns giving the user a consistent shooting experience with respect to the stock's fit and feel. The ability to segment the custom manufacturing of a gun stock provides the user and the manufactures with signification flexibility to efficiently produce customized gun stocks.

In some embodiments, at least a portion of the present invention is implemented in software. Software programming code which embodies the present invention is typically accessed by the microprocessor (e.g. a computer 140) from long-term storage media of some type, such as a CD-ROM drive or hard drive. The software programming code may be embodied on any of a variety of known media for use with a data processing system, such as a diskette, hard drive, or CD-ROM. The code may be distributed on such media, or may be distributed from the memory or storage of one computer system over a network of some type to other computer systems for use by such other systems. Alternatively, the programming code may be embodied in the memory and accessed by the microprocessor using the bus. The techniques and methods for embodying software programming code in memory, on physical media and/or distributing software code via networks are well known and will not be further discussed herein.

A user of the present invention may connect his computer to a server using a wireline connection, or a wireless connection. (Alternatively, the present invention may be used in a stand-alone mode without having a network connection.) Wireline connections are those that use physical media such as cables and telephone lines, whereas wireless connections use media such as satellite links, radio frequency waves and infrared waves. Many connection techniques can be used with these various media, such as: using the computer's modem to establish a connection over a telephone line, using a LAN card such as Token Ring or Ethernet, using a cellular modem to establish a wireless connection, etc. The user's computer may be any type of computer processor, including laptop, handheld or mobile computers; vehicle-mounted devices; desktop computers; mainframe computers; etc., having processing capabilities (and communication capabilities, when the device is network-connected). The remote server, similarly, can be one of any number of different types of computer which have processing and communication capabilities. These techniques are well known in the art, and the hardware devices and software which enable their use are readily available. Note that herein the user's computer will be referred to equivalently as a “workstation”, “device”, or “computer”, and use of any of these terms or the term “server” refers to any of the types of computing devices described above.

According to one implementation of the present invention, the system may occur in a Web environment, where software installation packages are downloaded using a protocol such as the HyperText Transfer Protocol (HTTP) from a Web server to one or more target computers that are connected through the Internet. Alternatively, an implementation of the present invention may be executing in other non-Web networking environments (using the Internet, a corporate intranet or extranet or any other network). Configurations for the environment include a client/server network, as well as a multi-tier environment. Or, as stated above, the present invention may be used in a stand-alone environment rather than across a network connection. Furthermore, it may happen that the client and server of a particular installation both reside in the same physical device, in which case a network connection is not required. These environments and configurations are well known in the art.

As will be understood by those familiar with the art, the invention may be embodied in other specific forms without departing from the spirit or essential characteristics thereof. Likewise, the particular naming and division of the modules, managers, functions, systems, engines, layers, features, attributes, methodologies, and other aspects are not mandatory or significant, and the mechanisms that implement the invention or its features may have different names, divisions, and/or formats. Furthermore, as will be apparent to one of ordinary skill in the relevant art, the modules, managers, functions, systems, engines, layers, features, attributes, methodologies, and other aspects of the invention can be implemented as software, hardware, firmware, or any combination of the three. Of course, wherever a component of the present invention is implemented as software, the component can be implemented as a script, as a stand-alone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment. Accordingly, the disclosure of the present invention is intended to be illustrative, but not limiting, of the scope of the invention, which is set forth in the following claims.

While there have been described above the principles of the present invention in conjunction with a system and method to fabricate a custom gun stock, it is to be clearly understood that the foregoing description is made only by way of example and not as a limitation to the scope of the invention. Particularly, it is recognized that the teachings of the foregoing disclosure will suggest other modifications to those persons skilled in the relevant art. Such modifications may involve other features that are already known per se and which may be used instead of or in addition to features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The Applicant hereby reserves the right to formulate new claims to such features and/or combinations of such features during the prosecution of the present application or of any further application derived therefrom.

We claim:

1. A Computer Aided Design (“CAD”)/Computer Aided Machining (“CAM”) system for design and manufacture of a stock for a gun comprising;
a plurality of stock design modules;
a library configured to store the plurality of stock design modules;
a set of data representing physical characteristics of a user;
a subset of the plurality of stock design modules wherein each stock design module within said subset of stock design modules is selected based on physical characteristics of the user; and
a computing device, the computing device being adapted for reception and processing of the set of data representing the physical characteristics of the user, formation of a three-dimensional computer model of the stock based on the set of data and the subset of the plurality of stock design modules, and outputting of data representing the computer model for production of the stock based on the computer model.

2. The system of claim 1 wherein said system is further adapted for selection of shape, dimension, and position of a cavity in the stock for receiving and mating the stock with the gun.

3 The system of claim 2 wherein the cavity in the stock for receiving and mating with the gun is formed to accommodate a trigger housing and a gun base plate.

4. The system of claim 1 wherein the subset of the plurality of stock design modules includes a first module having a first end and a second end, the first end configured to mate with the gun.

5. The system of claim 4 wherein the subset of the plurality of stock design modules includes a second module configured to mate with the second end of the first module.

6. The system of claim 5 wherein attributes of the first module and attributes of the second module are modifiable based on physical characteristics of the user.

7. The system of claim 1 wherein the stock is manufactured from a unitary piece of stock material.

8. The system of claim 1 wherein the subset of design modules is selected based on the intended use of the gun.

9. The system of claim 1 wherein the formation of the three-dimensional computer model based on the set of data and the subset of the plurality of stock design modules, and outputting of data representing the computer model for production of the stock based on the computer model can be segmented such that a first portion of the three-dimensional computer module may be formed and outputted for production separate from a second portion of the three-dimensional model.

10. The system of claim 9 wherein the first portion of three-dimensional computer model and the second portion of the three-dimensional computer model of the stock can machined at two distinct periods of time.

11. A method for manufacturing a stock of a gun using Computer Aided Design (“CAD”)/Computer Aided Machining (“CAM”), the method comprising:
collecting a set of data representing the physical characteristics of the user;
accessing a library housing a plurality of stock design modules;
selecting a subset of stock design modules from the plurality of stock design modules based on the set of data representing the physical characteristics of the user;
processing at a computer the set of data and the subset of stock design modules to form a three-dimensional computer model of the stock; and
outputting data representing the computer model of the stock to a CAM machine for production of the stock based on the computer model.

12. The method of claim 11 further comprising determining shape, dimension, and position of a cavity within the stock for receiving and mating the stock with the gun.

13. The method of claim 12 wherein the cavity in the stock for receiving and mating with the gun is formed to accommodate a trigger housing and a gun base plate.

14. The method of claim 11 wherein each stock design module of the subset of the plurality of stock design modules is joined to form a preliminary three-dimensional computer model of the stock.

15. The method of claim 14 wherein attributes of the preliminary three-dimensional computer model of the stock are modifiable based on physical characteristics of the user.

16. The method of claim 11 wherein production of the stock is from a unitary piece of stock material.

17. The method of claim 11 wherein the subset of design modules is selected based on the intended use of the gun.

18. The method of claim 11 wherein the computer model can be segmented such that a first portion of the subset of stock design modules can be processed to form a first portion of the computer model and the first portion of the computer model can be output for production of a first portion of the stock separate from a second portion of the subset of stock design modules that from a second portion of the computer model.

19. A stock for a gun manufactured using Computer Aided Design (“CAD”)/Computer Aided Machining (“CAM”); the stock comprising:
a unitary piece of stock material manufactured by a CAM machine in accordance with a computer model of the stock generated by a computer wherein the computer model was formed by processing data representing physical characteristics of a user in combination with a set of stock design modules and wherein a cavity within the unitary piece of stock material is formed for receiving and mating the stock with the gun.

20. The stock of claim 19 wherein the set of design modules is selected from a plurality of design modules stored in a library, said library being accessible by the computer.

21. The stock of claim 20 wherein each stock design module includes a plurality of attributes and where each attribute is modifiable prior to manufacturing.

22. The stock of claim 21 wherein the plurality of attributes includes exterior dimensions and contours of the stock.

23. A computer system for fabricating a stock of a gun, the computer system comprising:
a machine capable of executing instructions embodied as software; and
a plurality of software portions, wherein
one of said software portions is configured to collect a set of data representing the physical characteristics of a user;
one of said software portions is configured to store on a tangible storage medium said set of data;
one of said software portions is configured to access a library housing a plurality of stock design modules;
one of said software portions is configured to select a subset of stock design modules from the plurality of stock design modules based on the set of data representing the physical characteristics of the user and the intended use of the gun;
one of said software portions is configured to form a three-dimensional computer model of the stock using the set of data and the subset of stock design modules;
one of said software portions is configured to modify the three-dimensional computer model of the stock; and
one of said software portions is configured to output data representing the modified three-dimensional computer model of the stock to a computer aided machining device for production of the stock based on the modified three-dimensional computer model.

24. The computer system of claim 23 wherein one of the said software portions is configured to segment forming of the three-dimensional computer model into a plurality of portions and wherein each portion can be modified and output for machining independently.
